(19) United States
(12) Patent Application Publication
(10) Pub. No.: US 2021/0066774 A1
(43) Pub. Date: Mar. 4, 2021

(54) DIELECTRIC TM01 MODE RESONATOR

(71) Applicant: CommScope Technologies LLC, Hickory, NC (US)

(72) Inventors: Martin Kufa, Chlumec nad Cidlinou (CZ); Frantisek Ondrácek, Pardubice (CZ); Pavel Sirucek, Chvaletice (CZ); Tomás Thér, Police nad Metuji (CZ); Lubomír Bahník, Pardubice (CZ)

(73) Assignee: CommScope Technologies LLC, Hickory, NC (US)

(21) Appl. No.: 16/996,535

(22) Filed: Aug. 18, 2020

Related U.S. Application Data
(60) Provisional application No. 62/894,932, filed on Sep. 2, 2019.

(51) Int. Cl. H01P 1/208; H01P 1/213; H01P 7/10

(52) U.S. Cl. CPC H01P 1/2084; H01P 7/10; H01P 1/2138

(57) ABSTRACT

Systems and methods for dielectric TM₀₁ mode resonators are described herein. In certain embodiments, a system includes one or more electronic devices, wherein an electronic device a first input signal and provides an output signal. Further, the electronic device includes a conductive body enclosing a cavity, wherein the cavity has an interior surface. Additionally, the electronic device includes one or more dielectric resonators, wherein a dielectric resonator in the one or more dielectric resonators comprises two or more portions that are shaped differently than one another and has an axial center cavity formed therein. Moreover, the electronic device includes one or more tuning elements inserted through an external surface of the conductive body, the one or more tuning elements extending through the external surface into the axial center cavity, wherein a distance that the one or more tuning elements extend into the axial center cavity is adjustable.

### CROSS-REFERENCE TO RELATED APPLICATIONS

This application claims the benefit of U.S. Provisional Patent Application Ser. No. 62/894,932 entitled “DIELECTRIC TM01 MODE RESONATOR” filed on Sep. 2, 2019, which is incorporated herein by reference in its entirety.

### BACKGROUND

Communication products frequently include RF filters, duplexers, multiplexers, repeaters, connectors, and other similar communication components. Sometimes, these components may include cavities, where electromagnetic fields can propagate within the cavities. Frequently, the transverse electromagnetic (TEM) mode of the electromagnetic fields may propagate within these components as the dominant mode. Alternatively, the component design may excite the transverse magnetic (TM) mode (or higher TM and/or transverse electric (TE) modes) of the propagating electromagnetic fields as the dominant mode. If the component design excites other non-dominant modes, the total power of the non-dominant modes may be multiple dB below the power of the dominant mode.

Frequently, filters and other components may include one or more resonator assemblies. A resonator assembly may include a conductive body that encompasses a cavity. Also, the conductive body may enclose one or more resonators mounted within the cavity. A resonator may be a piece of dielectric material (such as a ceramic) that functions as a resonator for radio waves to generate signals at resonant frequencies for the communication of signals. The resonators may filter out frequencies and pass signals at the resonant frequencies.

### SUMMARY

Systems and methods for dielectric TM₀₁ mode resonators are described herein. In certain embodiments, a system includes one or more electronic devices, wherein at least one electronic device in the one or more electronic devices receives a first input signal and provides an output signal. Further, the at least one electronic device includes a conductive body enclosing a cavity, wherein the cavity has an interior surface. Additionally, the at least one electronic device includes one or more dielectric resonators, wherein a dielectric resonator in the one or more dielectric resonators comprises two or more portions that are shaped differently than one another and has an axial center cavity formed therein. Moreover, the at least one electronic device includes one or more tuning elements inserted through an external surface of the conductive body, the one or more tuning elements extending through the external surface into the axial center cavity, wherein a distance that the one or more tuning elements extend into the axial center cavity is adjustable.

### DRAWINGS

Understanding that the drawings depict only some embodiments and are not, therefore, to be considered limiting in scope, the exemplary embodiments will be described with additional specificity and detail using the accompanying drawings, in which:

FIG. 1 is a block diagram illustrating an isometric drawing of a filter having a dominant TM₀₁ mode that uses single-ended dielectric resonators (DR) according to an aspect of the present disclosure;

FIG. 2A is a graph showing the magnetic (H) fields within the filter of FIG. 1, according to an aspect of the present disclosure;

FIG. 2B is a graph showing the electric (E) fields within the filter of FIG. 1, according to an aspect of the present disclosure;

FIG. 3 is a cross-section diagram illustrating a pedestal-mounted dielectric resonator installed within a cavity;

FIG. 4 is a cross-section diagram illustrating a dielectric resonator mounted directly to a surface of a cavity according to an aspect of the present disclosure;

FIG. 5 is a cross-section diagram illustrating a dielectric resonator mounted within a cavity, wherein a portion of the dielectric resonator aids in controlling higher modes according to an aspect of the present disclosure;

FIG. 6A is a cross-section diagram illustrating an additional tuning element inserted within a dielectric resonator directly mounted to a surface of a cavity according to an aspect of the present disclosure;

FIG. 6B is a cross-section diagram illustrating an additional tuning element inserted within a pedestal-mounted dielectric resonator according to an aspect of the present disclosure;

FIG. 7A is a block diagram illustrating a distributed antenna system having components that may use dielectric resonators according to an aspect of the present disclosure;

FIG. 7B is a block diagram illustrating a remote antenna unit having components that may use dielectric resonators according to an aspect of the present disclosure; and

FIG. 8 is a block diagram illustrating a single-node repeater having components that may use dielectric resonators according to an aspect of the present disclosure.

Per common practice, the various described features are not drawn to scale but are drawn to emphasize specific features relevant to the example embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made.

The present disclosure describes various embodiments of dielectric TM₀₁ mode resonators. For example, as compared to other single and multi-band RF filters and other components that have TEM as the dominant mode, embodiments disclosed in the present description disclose systems and methods that use resonators in electronic devices or other components that have TM₀₁ as the dominant mode. Components with a TM₀₁ dominant mode allow for the use of design approaches and materials that reduce insertion losses by up to fifty percent. Further, components with a TM₀₁ dominant mode may also allow for the significant reduction of the size and weight of the components.

As disclosed in the present application, RF components or other electronic devices may have interior cavities with dielectric resonators mounted within the cavities. For example, a dielectric resonator may be a hollow, ceramic cylinder, where one of the planar ends of the hollow cylinder adheres to a surface of the cavity within the RF component. Directly adhering the dielectric resonator to the surface of the cavity (as compared to mounting the dielectric resonator on a metallic or plastic (Ag coated) pedestal) may further reduce insertion losses within the component and increase the unloaded Q factor of the dielectric resonator. Also, by directly adhering the dielectric resonator to the surface of the cavity may reduce intermodulation distortion caused by the use of solder to mount dielectric resonators to cavity surfaces.

Further, the dielectric resonator may have a unique shape that increases the frequency separation between the dominant TM₀₁ mode and higher modes (TM and/or TE). A tuning element inserted into the dielectric resonator may provide additional separation of the TM₀₁ from the TE modes and higher TM modes. For example, the tuning element may insert into a planar side of the dielectric resonator, where the planar side contacts an interior surface of the cavity. Because of the unique shape of the dielectric resonator, the insertion of a tuning element into the dielectric resonator, and the commensurate separation achieved between the dominant mode and other modes, the original resonator assembly may use nonmetal parts. For example, the original resonator assembly may use parts fabricated from plastic and/or dielectric materials that may or may not have metal coatings, such as silver (Ag) coatings. Using plastic and/or dielectric materials may reduce the weight and cost of resultant components.

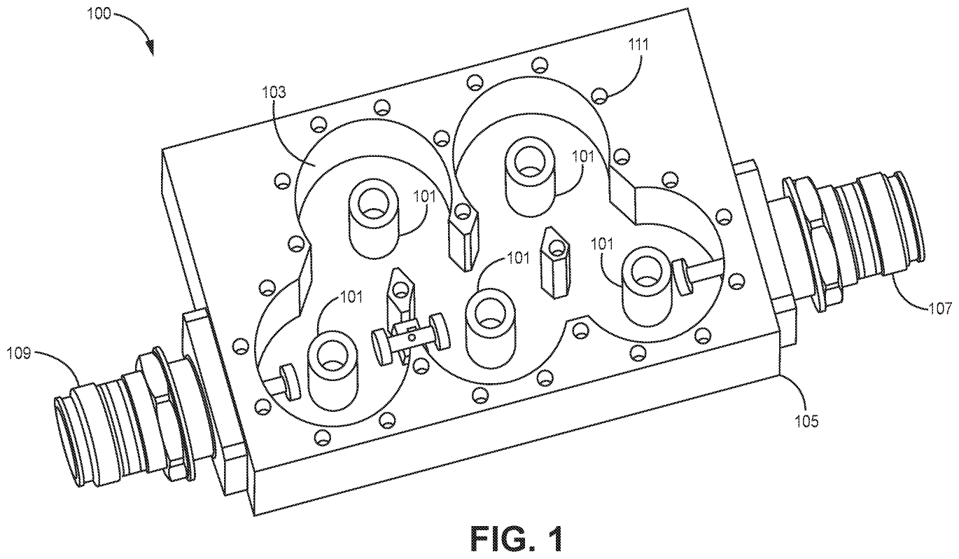

FIG. 1 is an isometric illustration of a filter 100 having a dominant TM₀₁ mode. As used within the present application, a filter may refer to an electronic device that reduces the power of unwanted frequency components in a received signal. The filter 100 may include connectors 107 and 109 that function as ports for receiving signals through one of the connectors 107 and 109, where a received signal has unwanted frequency components. The filter 100 may reduce the power of the unwanted frequency components and transmit the filtered signal through one of the connectors 107 and 109. For example, the filter 100 may receive a signal as an input signal through the connector 107, reduce the power of the unwanted frequency components, and transmit the filtered signal as an output signal of the filter 100 through the connector 109. Conversely, the filter 100 may receive an input signal through the connector 109 and transmit the filtered output signal through the connector 107.

In certain embodiments, to provide the filtering, the filter 100 may include a conductive body 105 with an interior cavity 103. As used within the present application, the conductive body may refer to an object where the surface of the body is conductive. For example, the conductive body 105 may be fabricated from a solid piece of metal. In some implementations, the conductive body 105 may be formed from a solid piece of metal that is coated by a metal coating made from another metal such as Ag, copper (Cu), gold (Au), tin (Sn). Alternatively, the conductive body 105 may be fabricated from plastic or other dielectrics, where the surface of the conductive body 105 has a metal coating, such as a coating of Ag, copper (Cu), gold (Au), tin (Sn). In some implementations calling for smaller weight and size for the filter 100, using a metal-coated dielectric may reduce the weight of the filter 100 or other similar component.

In some embodiments, when the filter 100 receives a signal through one of the connectors 107 and 109, the signal may propagate through the cavity 103, such that the filter 100 outputs the signal on a different connector 107 and 109. For example, the filter 100 may receive a signal through the connector 109. The signal may propagate through the cavity 103 to be output through the connector 107. Alternatively, the cavity 103 may reflect a received signal such that the filter 100 outputs and receives the signal through the same one of the connectors 107 and 109. For example, the filter 100 may receive a signal through the connector 109, the cavity 103 may reflect the received signal, and the filter 100 may output the signal through the connector 109.

In further embodiments, within the cavity 103, the filter 100 may include one or more dielectric resonators 101. As described in the present application, a dielectric resonator 101 may refer to a piece of non-conductive material, typically ceramic, that functions as a resonator for radio waves. In some embodiments, the dielectric resonator 101 may be a cylinder having an axial center cavity. A dielectric resonator 101 with an axial center cavity, as compared to a solid cylinder, may provide greater separation from a dominant mode for the filter 100 and other modes. For example, the axial center cavity in the filter 100 may have a dominant mode that is the TM₀₁ mode. The shape of the dielectric resonator 101 significantly reduces magnetic fields in the direction of signal propagation.

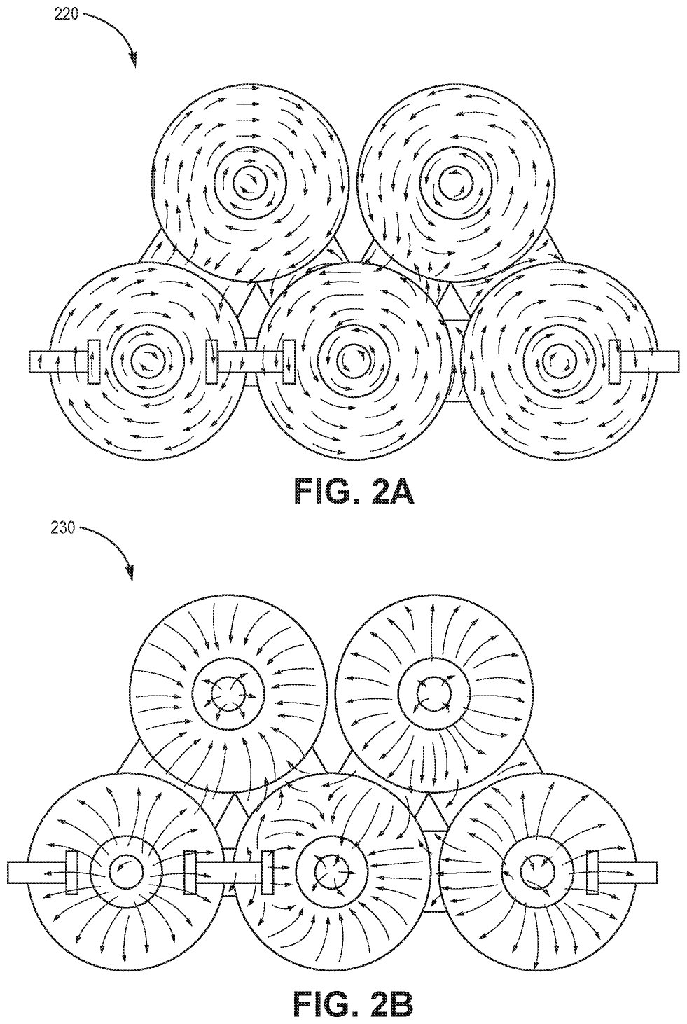

FIGS. 2A and 2B illustrate maps of the electric and magnetic field vectors present within the filter 100 for the TM₀₁ mode. In particular, FIG. 2A is a diagram showing a mapping 220 of the magnetic field vectors at various locations within the filter 100. As illustrated, the magnetic fields are perpendicular to the direction of propagation through the filter 100. Also, FIG. 2B is a diagram showing a mapping 230 of the electric field vectors at the various locations within the filter 100. In contrast to the magnetic fields, the electric field vectors are not perpendicular to the direction of propagation. As the dielectric resonator 101 is a hollow cylinder, the dominant TM₀₁ mode may be separated from higher TM modes and also separated from TE modes. Further, the shape of the dielectric resonator 101 may increase the separation between the dominant mode and other modes.

FIG. 1 illustrates the filter 100 with a removed cover to show the cavity 103 and the components within the cavity 103. A cover (not shown) may mount to the conductive body 105 to enclose the cavity 103. The cover may be fabricated from metal, metal-coated plastic, or any other metal-coated material. The cover may include several holes that correspond to holes 111 on the conductive body 105 to facilitate the mounting of the cover to the conductive body 105. Screws or bolts may be inserted through holes in the cover to engage the surfaces of the holes 111 in the conductive body 105. The screws or bolts may be tightened to secure the cover to the conductive body 105.

In additional embodiments, as described in greater detail below, the cover may have additional holes associated with the locations of the dielectric resonators 101. The holes in the cover may allow a tuning element to be inserted through an external surface of the cavity 103 into the dielectric resonators 101. The tuning element may be a screw that changes the resonant frequency of the dominant mode for the resonator within the filter 100, where the resonant frequency of the dominant mode is based on the distance that the tuning element extends into a dielectric resonator 101. In additional embodiments, the conductive body 105 may have holes in the bottom side of the conductive body 105. The holes in the bottom side may correspond to the locations of the dielectric resonators 101 in the cavity 103. The holes in the bottom side may facilitate the insertion of additional tuning elements into the dielectric resonators 101. The tuning elements inserted through the bottom side of the filter 100 may further increase the separation between the dominant mode and other modes. As used in the present application, the “bottom side” of a component (like the filter 100) may refer to the side opposite the side associated with the cover or the side of the component in contact with the dielectric resonators 101. As such, the “top side” of a component (like the filter 100) may refer to the side that mates with the cover or the side in contact with the dielectric resonators 101. The tuning elements, both those inserted through the cover and the bottom side of the filter 100, may be fabricated from metal, a dielectric, metal-coated dielectrics/plastics, or combination of materials.

As described in greater detail below, the use of tuning elements and the shape of the dielectric resonators 101 may facilitate the use of dielectric components as compared to using metal components. Typically, metal components provide greater frequency separation between the dominant TEM mode and other modes. For example, concerning the filter 100, metal components may provide greater frequency separation between the TM₀₁ mode and the higher (TM and/or TE) modes. However, metal components have higher insertion losses and higher weight. As tuning elements and the shape of the dielectric resonators 101 increase the frequency separation between the dominant mode and other modes, cheaper lighter dielectric components may be used, decreasing the cost of the filter 100 and other component designs implementing dielectric resonators 101 that have a dominant TM₀₁ mode. While the filter 100 is described herein to illustrate the use of the dielectric resonators 101 within the 103, other electronic devices having cavities may also benefit from using the dielectric resonators 101 described in this specification.

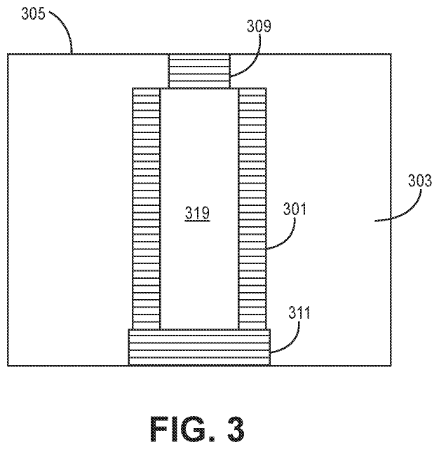

FIG. 3 is a cross-section diagram of a dielectric resonator 301 mounted within a cavity 303. As discussed above, the dielectric resonator 301 may be fabricated from a dielectric, such as ceramic, plastic, or other dielectric. Further, the dielectric resonator 301 may have a axial center cavity 319 extending through the dielectric resonator 301 such that the dielectric resonator 301 is a hollow cylinder. As discussed above, the axial center cavity 319 aids in separating the frequency of the dominant mode from the frequency of other modes.

In some embodiments, the dielectric resonator 301 may mount to an interceding pedestal 311 in the cavity 303. The interceding pedestal 311 may attach to a surface within the cavity 303. As used in the present application, the interceding pedestal 311 may refer to an object that facilitates the mounting of the dielectric resonator 301 to a surface of the cavity 303 within a conductive body (such as the conductive body 105 in FIG. 1). The interceding pedestal 311 may be fabricated from metal or fabricated from a dielectric material. The interceding pedestal 311 may be coated with a metal (like Ag, Cu, Au or Sn). In some embodiments, during manufacturing, the interceding pedestal 311 be fixedly attached to the dielectric resonator 301. During installation within the cavity 303, the interceding pedestal 311 (and the attached dielectric resonator 301) may mount to a surface of the cavity 303. The interceding pedestal 311 may be soldered, or fixed in other ways, to the surface of the cavity 303 at a specific location within the cavity 303.

When the interceding pedestal 311 and the dielectric resonator 301 are mounted within the cavity 303, a tuning element 309 may be inserted through a hole in the top side 305 of the cavity 303, where the hole corresponds with the location of the dielectric resonator 301 within the cavity 303. The tuning element 309 may be inserted into the hole and extend down into the axial center cavity 319 to a particular depth that corresponds with the desired resonant frequency of the dielectric resonator 301. The tuning element 309 may be fabricated from a dielectric material or metal. Also, a tuning element 309 may be metal plated with a metal (like Ag, Cu, Au or Sn).

In certain embodiments, to install the dielectric resonator 301 within the cavity 303, the interceding pedestal 311, as described above, is soldered at a desired location on an interior surface of the cavity 303 when the cover of the cavity 303 is removed. The cover may be placed over the cavity 303 and secured to the conductive body containing the cavity. When the cover is secured, a technician may insert a tuning element 309 through a hole in the top side 305 of the cavity into the axial center cavity 319 of the dielectric resonator 301 to a desired depth to tune the resonant frequency of the TM₀₁ dominant mode to a desired frequency.

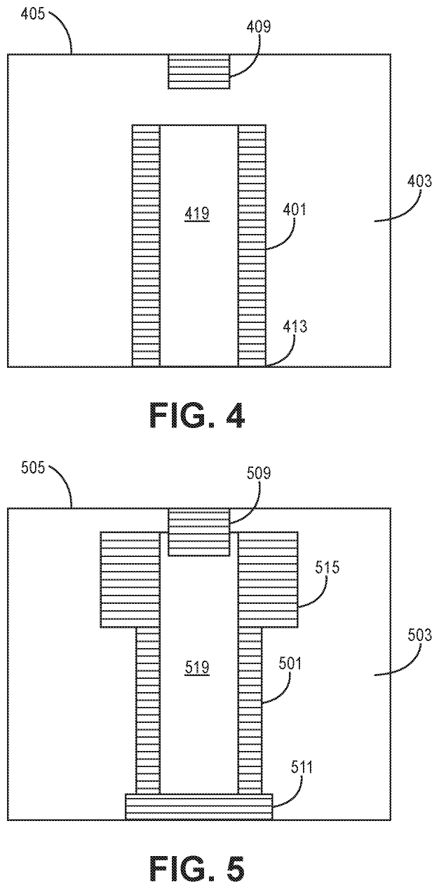

FIG. 4 is a cross-section diagram of a dielectric resonator 401 mounted within the cavity 403. As shown, the tuning element 409, the cavity 403, the top side 405, and the axial center cavity 419 may be similar to the tuning element 309, the cavity 303, the top side 305, and the axial center cavity 319 described above concerning FIG. 3. In contrast to the dielectric resonator 301 discussed above in FIG. 3, a dielectric surface of the dielectric resonator 401 may mount directly to the interior surface of the cavity 403 without an interceding structure, such as the interceding pedestal 311. An adhesive 413 (or other similar material) may be applied to one or both of a surface of the dielectric resonator 401 and a desired location on the interior surface of the cavity 403. The cavity 403 may be placed at the desired location, where the adhesive 413 may adhere the dielectric resonator 401 to the desired location within the cavity 403. When the adhesive 413 cures, the dielectric resonator 401 may be fixedly attached to the interior surface of the cavity 403. The mounting of the dielectric resonator 401 directly to the interior surface of the cavity 403 without an interceding pedestal may reduce insertion losses by up to 50% and significantly increase an unloaded Q value for the dielectric resonator 401. Also, using the adhesive 413, as compared to solder, may reduce intermodulation distortion.

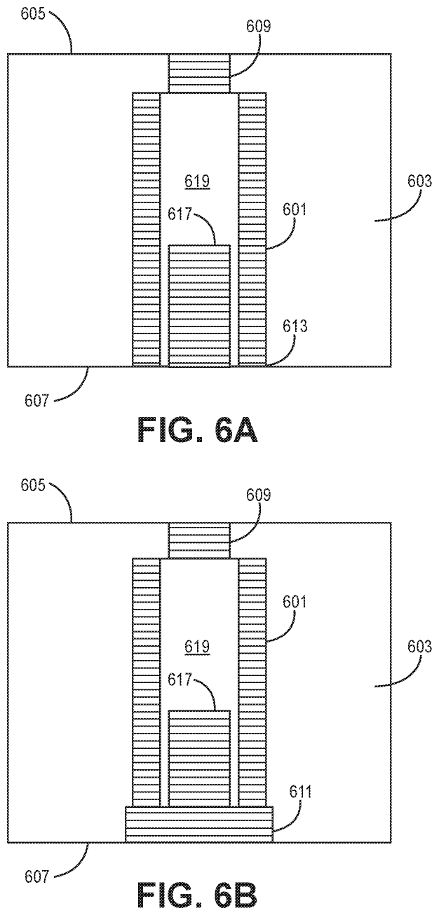

FIG. 5 is a cross-section diagram of a dielectric resonator 501, where a portion 515 of the dielectric resonator 501 aids in controlling the frequency separation between the dominant TM₀₁ mode and higher (TM and/or TE) modes. As shown, the dielectric resonator 501 is mounted within a cavity 503. The tuning element 509, cavity 503, pedestal 511, and top side 505 may be similar to the tuning element 309, cavity 303, interceding pedestal 311, and top side 305 discussed above relative to FIG. 3.

In certain embodiments, the dielectric resonator 501 may have two or more portions that have different shapes. For example, the dielectric resonator 501 may include a portion 515 of the dielectric resonator 501 that has a different shape than other portions of the dielectric resonator 501. Specifically, the thickness of the wall of the dielectric resonator 501 in the portion 515 that surrounds the axial center cavity 519 may have a different thickness than other portions of the dielectric resonator 501 that surround the axial center cavity 519. In particular, the thickness of the wall of the dielectric resonator 501 in the portion 515 may be thicker than the wall at other portions of the dielectric resonator 501. The shape of the portion 515 of the dielectric resonator 501 may be altered in other manners to shift the resonant frequencies of the higher (TM and/or TE) modes to higher frequencies. Because the shape of the portion 515 causes higher (TM and/or TE) modes to shift to higher frequencies, the use of the portion 515 increases the frequency separation between the TM₀₁ and higher modes. Increasing the frequency separation may reduce parasitic effects such as parasitic internal oscillations at other non-dominant modes and in-band distortion. Using the portion 515 may reduce the parasitic effects by reducing the probability of in-band signals exciting a TE mode or a TM mode other than the TM₀₁ dominant mode.

While FIG. 5 shows the dielectric resonator 501 mounted on an interceding pedestal 511, the dielectric resonator 501, having the portion 515, may be mounted on an interceding pedestal 511 or directly adhered to an interior surface of the cavity 503 as described above with relation to FIG. 4. Also, the portion 515 of the dielectric resonator 501 may be used with a tuning element 509 as described above.

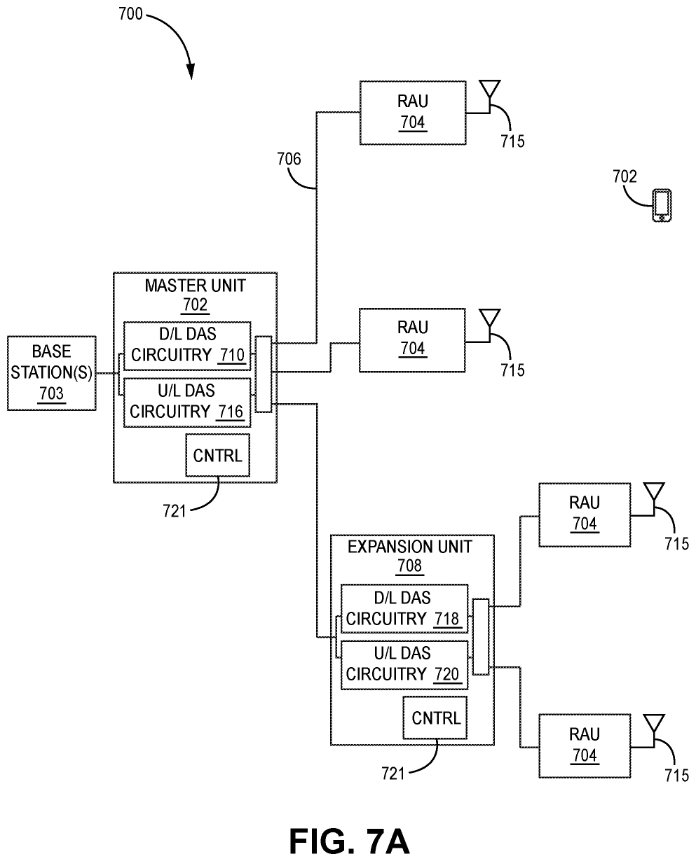

FIGS. 6A and 6B are cross-section diagrams of a dielectric resonator 601 having an additional tuning element 617 inserted into the dielectric resonator 601. As shown, FIG. 6A illustrates the use of a tuning element 617 that is inserted into a dielectric resonator 601 through the bottom side 607 of a conductive body enclosing the cavity 603. As shown, the dielectric resonator 601 may be directly adhered to an interior surface of the cavity 603 using an adhesive 613 like the dielectric resonator 401 is adhered to the interior surface of the cavity 403 using an adhesive 413 as described above in FIG. 4. Alternatively, FIG. 6B illustrates the use of a tuning element 617 that is inserted into a dielectric resonator 601 through a bottom side 607 on the external surface of a conductive body, where the dielectric resonator 601 is mounted on an interceding pedestal 611 as described above in FIG. 3. With FIGS. 6A and 6B, the top side 605 and the tuning element 609 may be similar to the top side 305 and the tuning element 309 described above concerning FIG. 3.

In certain embodiments, the tuning element 617 may be inserted through the bottom side 607 of the conductive body into the axial center cavity 619 of the dielectric resonator 601. The tuning element 617 may be a screw that may be fabricated from a metal material (such as stainless steel) or a metal-plated dielectric material. The tuning element 617 may be plated with a metal, such as Ag, Cu, Au, or Sn. The tuning element 617 may be adjusted to control the extent that the tuning element 617 extends into the axial center cavity 619 of the dielectric resonator 601. Using the tuning element 617 may shift the resonant frequencies of the higher (TM and/or TE) modes to higher frequencies to increase the frequency separation between the TM₀₁ dominant mode and the non-dominant higher modes. As discussed above, increasing the frequency separation may reduce parasitic effects, such as parasitic internal oscillations at non-dominant modes and in-band distortion by reducing the chances that an in-band signal excites a non-dominant TE mode or a non-dominant TM mode.

In certain embodiments, using metal for the resonator, pedestal, and tuning elements may naturally increase the frequencies of the TE modes and higher non-dominant TM modes but using dielectric resonator for one or more of these components decreases the frequency separation between the non-dominant modes and the desired TM₀₁ dominant mode. Implementing the different shaped portions 515 of the resonator 501, described in FIG. 5, and the tuning element 617, described in FIGS. 6A and 6B, may increase the frequencies of the unwanted non-dominant modes to counter the effects of using dielectric components.

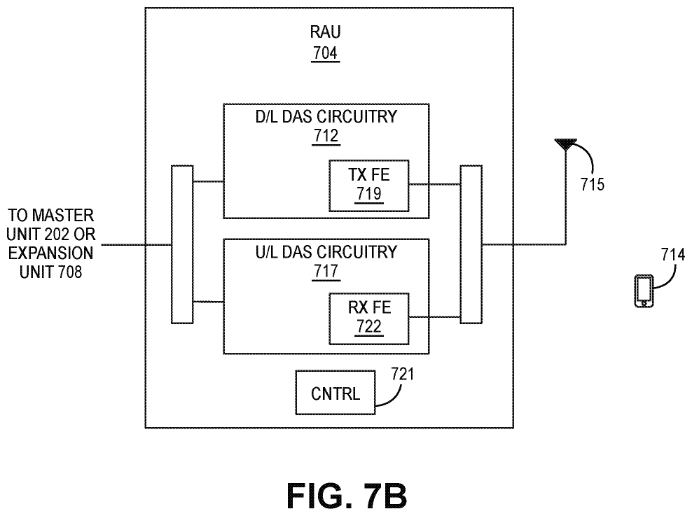

Using the above-described resonators in components with a dominant TM₀₁ mode may improve the performance of multiple systems. For example, filters and duplexers used in a distributed antenna system (DAS) may improve their performance by using the above-described resonators. FIG. 7A illustrates one embodiment of a distributed antenna system 700 that uses the above-described resonators.

The DAS 700 comprises one or more master units 702 that are communicatively coupled to one or more remote antenna units (RAUs) 704 via one or more waveguides 706, e.g., optical fibers or cables. Each remote antenna unit 704 can be communicatively coupled directly to one or more of the master units 702 or indirectly via one or more other remote antenna units 704 and/or via one or more expansion (or other intermediary) units 708.

The DAS 700 is coupled to one or more base stations 703 and is configured to improve the wireless coverage provided by the base stations 703.

The capacity of each base station can be dedicated to the DAS or can be shared among the DAS and a base station antenna system that is co-located with the base station and/or one or more other repeater systems.

In the embodiment shown in FIG. 7A, the capacity of one or more base stations 703 are dedicated to the DAS 700 and are co-located with the DAS 700. The base stations 703 are coupled to the DAS 700. It is to be understood, however, that other embodiments can be implemented in other ways. For example, the capacity of one or more base stations 703 can be shared with the DAS 700 and a base station antenna system co-located with the base stations 703 (for example, using a donor antenna).

The base stations 703 can include one or more base stations that are used to provide commercial cellular wireless service and/or one or more base stations that are used to provide public and/or private safety wireless services (for example, wireless communications used by emergency services organizations (such as police, fire, and emergency medical services) to prevent or respond to incidents that harm or endanger persons or property).

The base stations 703 can be coupled to the master units 702 using a network of attenuators, combiners, splitters, amplifiers, filters, cross-connects, etc., (sometimes referred to collectively as a “point-of-interface” or “POI”). This network can be included in the master units 702 and/or can be separate from the master units 702. This is done so that, in the downlink, the desired set of RF channels output by the base stations 703 can be extracted, combined, and routed to the appropriate master units 702, and so that, in the upstream, the desired set of carriers output by the master units 702 can be extracted, combined, and routed to the appropriate interface of each base station 703. It is to be understood, however, that this is one example and that other embodiments can be implemented in other ways.

In general, each master unit 702 comprises downlink DAS circuitry 710 that is configured to receive one or more downlink signals from one or more base stations 703. Each base station downlink signal includes one or more radio frequency channels used for communicating in the downlink direction with user equipment 714 over the relevant wireless air interface. Typically, each base station downlink signal is received as an analog radio frequency signal. However, in some embodiments, one or more of the base station signals are received in a digital form (for example, in a digital baseband form complying with the Common Public Radio Interface (“CPRI”) protocol, Open Radio Equipment Interface (“ORI”) protocol, the Open Base Station Standard Initiative (“OBSAI”) protocol, or other protocol).

The downlink DAS circuitry 710 in each master unit 702 is also configured to generate one or more downlink transport signals derived from one or more base station downlink signals and to transmit one or more downlink transport signals to one or more of the remote antenna units 704.

FIG. 7B illustrates one embodiment of a remote antenna unit in which digital pre-distortion techniques described above can be implemented. Each remote antenna unit 704 comprises downlink DAS circuitry 712 that is configured to receive the downlink transport signals transmitted to it from one or more master units 702 and to use the received downlink transport signals to generate one or more downlink radio frequency signals that are radiated from one or more antennas 715 associated with that remote antenna unit 704 for reception by user equipment 714. In this way, the DAS 700 increases the coverage area for the downlink capacity provided by the base stations 703. The downlink DAS circuitry 712 of each RAU 704 includes at least one transmitter front end (TX FE) 719, which, for example, power amplifies the downlink radio frequency signals.

Also, each remote antenna unit 704 comprises uplink DAS circuitry 717 that is configured to receive one or more uplink radio frequency signals transmitted from the user equipment 714. These signals are analog radio frequency signals.

The uplink DAS circuitry 717 in each remote antenna unit 704 is also configured to generate one or more uplink transport signals derived from the one or more remote uplink radio frequency signals and to transmit one or more uplink transport signals to one or more of the master units 702. The uplink DAS circuitry 717 of each RAU 704 includes at least one receiver front end (RX FE) 722, which, for example, amplifies received remote uplink radio frequency signals.

Returning to FIG. 7A, each master unit 702 comprises uplink DAS circuitry 716 that is configured to receive the respective uplink transport signals transmitted to it from one or more remote antenna units 704 and to use the received uplink transport signals to generate one or more base station uplink radio frequency signals that are provided to the one or more base stations 703 associated with that master unit 702. Typically, this involves, among other things, combining or summing uplink signals received from multiple remote antenna units 704 to produce the base station signal provided to each base station 703. In this way, the DAS 700 increases the coverage area for the uplink capacity provided by the base stations 703.

Each expansion unit 708 comprises downlink DAS circuitry (D/L DAS circuitry) 718 that is configured to receive the downlink transport signals transmitted to it from the master unit 702 (or other expansion unit 708) and transmits the downlink transport signals to one or more remote antenna units 704 or other downstream expansion units 708. Each expansion unit 708 also comprises uplink DAS circuitry 720 that is configured to receive the respective uplink transport signals transmitted to it from one or more remote antenna units 704 or other downstream expansion units 708, combine or sum the received uplink transport signals, and transmit the combined uplink transport signals upstream to the master unit 702 or other expansion unit 708. In other embodiments, one or more remote antenna units 704 are coupled to one or more master units 702 via one or more other remote antenna units 704 (for example, where the remote antenna units 704 are coupled together in a daisy chain or ring topology).

The downlink DAS circuitry (D/L DAS circuitry) 710, 712, and 718 and uplink DAS circuitry (U/L DAS circuitry) 716, 717, and 720 in each master unit 702, remote antenna unit 704, and expansion unit 708, respectively, can comprise one or more appropriate connectors, attenuators, combiners, splitters, amplifiers, filters, duplexers, analog-to-digital converters, digital-to-analog converters, electrical-to-optical converters, optical-to-electrical converters, mixers, field-programmable gate arrays (FPGAs), microprocessors, transceivers, framers, etc., to implement the features described above. Also, the downlink DAS circuitry 710, 712, and 718 and uplink DAS circuitry 716, 717, and 720 may share common circuitry and/or components. These components may implement one or more of the resonators 301, 401, 501, and 601 along with any components having a dominant TM₀₁ mode.

The DAS 700 can use either digital transport, analog transport, or combinations of digital and analog transport for generating and communicating the transport signals between the master units 702, the remote antenna units 704, and any expansion units 708. Each master unit 702, remote antenna unit 704, and expansion unit 708 in the DAS 700 also comprises a respective controller (CNTRL) 721. The controller 721 is implemented using one or more programmable processors that execute software that is configured to implement the various control functions. The controller 721 (more specifically, the various control functions implemented by the controller 721) (or portions thereof) can be implemented in other ways (for example, in a field programmable gate array (FPGA), application specific integrated circuit (ASIC), etc.).

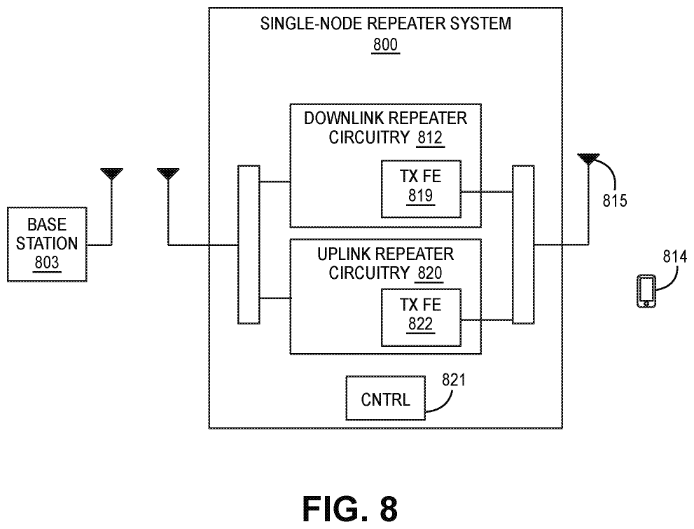

FIG. 8 illustrates one embodiment of a single-node repeater system 800 in which components therein may use resonators 301, 401, 501, and 601 along with components having a TM₀₁ dominant mode. The single-node repeater system 800 comprises downlink repeater circuitry 812 that is configured to receive one or more downlink signals from one or more base stations 803. These signals are also referred to here as “base station downlink signals.” Each base station downlink signal includes one or more radio frequency channels used for communicating in the downlink direction with user equipment (UE) 814 over the relevant wireless air interface. Typically, each base station downlink signal is received as an analog radio frequency signal.

The downlink repeater circuitry 812 in the single-node repeater system 800 is also configured to generate one or more downlink radio frequency signals that are radiated from one or more antennas 815 associated with the single-node repeater system 800 for reception by user equipment 814. These downlink radio frequency signals are analog radio frequency signals and are also referred to here as “repeated downlink radio frequency signals.” Each repeated downlink radio frequency signal includes one or more of the downlink radio frequency channels used for communicating with user equipment 814 over the wireless air interface. In this exemplary embodiment, the single-node repeater system 800 is an active repeater system in which the downlink repeater circuitry 812 comprises one or more amplifiers (or other gain elements) that are used to control and adjust the gain of the repeated downlink radio frequency signals radiated from the one or more antennas 815. The downlink repeater circuitry 812 includes at least one transmitter front end (TX FE) 819, which, for example, power amplifies the repeated downlink radio frequency signals.

Also, the single-node repeater system 800 comprises uplink repeater circuitry 820 that is configured to receive one or more uplink radio frequency signals transmitted from the user equipment 814. These signals are analog radio frequency signals and are also referred to here as “UE uplink radio frequency signals.” Each UE uplink radio frequency signal includes one or more radio frequency channels used for communicating in the uplink direction with user equipment 814 over the relevant wireless air interface.

The uplink repeater circuitry 820 in the single-node repeater system 800 is also configured to generate one or more uplink radio frequency signals that are provided to the one or more base stations 803. These signals are also referred to here as “repeated uplink signals.” Each repeated uplink signal includes one or more of the uplink radio frequency channels used for communicating with user equipment 814 over the wireless air interface. In this exemplary embodiment, the single-node repeater system 800 is an active repeater system in which the uplink repeater circuitry 820 comprises one or more amplifiers (or other gain elements) that are used to control and adjust the gain of the repeated uplink radio frequency signals provided to the one or more base stations 803. Typically, each repeated uplink signal is provided to the one or more base stations 803 as an analog radio frequency signal. The uplink repeater circuitry 820 includes at least one receiver front end (RX FE) 822, which, for example, amplifies received uplink radio frequency signals.

The downlink repeater circuitry 812 and uplink repeater circuitry 820 can comprise one or more appropriate connectors, attenuators, combiners, splitters, amplifiers, filters, duplexers, analog-to-digital converters, digital-to-analog converters, electrical-to-optical converters, optical-to-electrical converters, mixers, field-programmable gate arrays (FPGAs), microprocessors, transceivers, framers, etc., to implement the features described above. Also, the downlink repeater circuitry 812 and uplink repeater circuitry 820 may share common circuitry and/or components. The components described above may include one or more of the resonators 301, 401, 501, and 601. Also, the components may include cavities having a TM₀₁ dominant mode, as described above.

Further, a combination of two or more duplexers can be used to couple the at least one transmitter front end 819 and the at least one receiver front end 822 to one or more antennas 815. The single-node repeater system 800 also comprises a controller (CNTRL) 821. The controller 821 is implemented using one or more programmable processors that execute software that is configured to implement the various control functions. The controller 821 (more specifically, the various control functions implemented by the controller 821) (or portions thereof) can be implemented in other ways (for example, in a field programmable gate array (FPGA), application specific integrated circuit (ASIC), etc.).

### EXAMPLE EMBODIMENTS

Example 1 includes a system comprising: one or more electronic devices, wherein at least one electronic device in the one or more electronic devices receives a first input signal and provides an output signal, wherein the at least one electronic device comprises: a conductive body enclosing a cavity, wherein the cavity has a dominant TM₀₁ mode; and one or more components mounted within the cavity, wherein at least one of the one or more components is a resonator and some of the one or more components are dielectric components.

Example 2 includes the system of Example 1, wherein the resonator is a dielectric resonator having a dielectric surface adhered to an interior surface of the cavity.

Example 3 includes the system of any of Examples 1-2, wherein the resonator is a dielectric resonator that is mounted to an interior surface of the cavity through an interceding pedestal.

Example 4 includes the system of any of Examples 1-3, wherein at least one of the dielectric components are coated with a metal.

Example 5 includes the system of Example 4, wherein the metal is at least one of: silver; copper; gold; and tin.

Example 6 includes the system of any of Examples 1-5, wherein the resonator comprises two or more portions that are shaped differently than one another.

Example 7 includes the system of any of Examples 1-6, further comprising one or more tuning elements inserted through an external surface of the conductive body, the one or more tuning elements extending through the external surface into an axial center cavity formed in the resonator, wherein a distance that the one or more tuning elements extend into the axial center cavity is adjustable.

Example 8 includes the system of any of Examples 1-7, wherein the at least one electronic device is a filter.

Example 9 includes an apparatus comprising: a conductive body having a cavity within, wherein the cavity has a dominant TM₀₁ mode; and a dielectric resonator inserted into the cavity within the conductive body, wherein a dielectric surface of the dielectric resonator is adhered to an interior surface of the cavity.

Example 10 includes the apparatus of Example 9, wherein the dielectric resonator comprises two or more portions that are shaped differently than one another.

Example 11 includes the apparatus of Example 10, wherein the dielectric resonator is a hollow cylinder and a first portion in the two or more portions is thicker than a second portion in the two or more portions, and the second portion is between the dielectric surface adhered to the interior surface and the first portion.

Example 12 includes the apparatus of any of Examples 9-11, further comprising one or more tuning elements inserted through an external surface of the conductive body, the one or more tuning elements extending through the external surface into an axial center cavity formed in the dielectric resonator, wherein a distance that the one or more tuning elements extend into the axial center cavity is adjustable.

Example 13 includes the apparatus of any of Examples 9-12, wherein the dielectric surface adheres to the interior surface using an adhesive.

Example 14 includes an apparatus comprising: a conductive body having a cavity within, wherein the cavity has a dominant TM₀₁ mode; and a dielectric resonator mounted to an interior surface of the cavity, wherein the dielectric resonator comprises two or more portions that are shaped differently than one another.

Example 15 includes the apparatus of Example 14, wherein a dielectric surface of the dielectric resonator is adhered to the interior surface of the cavity.

Example 16 includes the apparatus of any of Examples 14-15, wherein the dielectric resonator is mounted to the interior surface of the cavity through an interceding pedestal.

Example 17 includes the apparatus of any of Examples 14-16, wherein the dielectric resonator is a hollow cylinder and a first portion in the two or more portions is thicker than a second portion in the two or more portions, and the second portion is between the first portion and a surface adhered to the dielectric resonator.

Example 18 includes the apparatus of any of Examples 14-17, further comprising one or more tuning elements inserted through an external surface of the conductive body, the one or more tuning elements extending through the external surface into an axial center cavity formed in the dielectric resonator, wherein a distance that the one or more tuning elements extend into the axial center cavity is adjustable.

Example 19 includes an apparatus comprising: a conductive body having a cavity within, wherein the cavity has an interior surface; one or more dielectric resonators mounted to the interior surface, wherein the one or more dielectric resonators have an axial center cavity formed therein; and one or more tuning elements inserted through an external surface of the conductive body, the one or more tuning elements extending through the external surface into the axial center cavity, wherein a distance that the one or more tuning elements extend into the axial center cavity is adjustable.

Example 20 includes the apparatus of Example 19, wherein a dielectric surface of a dielectric resonator in the one or more dielectric resonators is adhered to the interior surface of the cavity.

Example 21 includes the apparatus of any of Examples 19-20, wherein a dielectric resonator in the one or more dielectric resonators is mounted to the interior surface of the cavity through an interceding pedestal.

Example 22 includes the apparatus of any of Examples 19-21, further comprising an additional tuning element that extends through the external surface at a location opposite to an associated tuning element in the one or more tuning elements.

Example 23 includes the apparatus of any of Examples 19-22, wherein a tuning element in the one or more tuning elements is a screw.

Example 24 includes the apparatus of any of Examples 19-23, wherein a tuning element in the one or more tuning elements is made from at least one of: a metal; a dielectric material; and a metal-coated dielectric material, plastic or other metal-coated material.

Example 25 includes a system comprising: one or more electronic devices, wherein at least one electronic device in the one or more electronic devices receives a first input signal and provides an output signal, wherein the at least one electronic device comprises: a conductive body enclosing a cavity, wherein the cavity has an interior surface; one or more dielectric resonators, wherein a dielectric resonator in the one or more dielectric resonators comprises two or more portions that are shaped differently than one another and has an axial center cavity formed therein; and one or more tuning elements inserted through an external surface of the conductive body, the one or more tuning elements extending through the external surface into the axial center cavity, wherein a distance that the one or more tuning elements extend into the axial center cavity is adjustable.

Example 26 includes the system of Example 25, wherein a dielectric surface of the dielectric resonator is adhered to the interior surface of the cavity.

Example 27 includes the system of any of Examples 25-26, wherein the dielectric resonator is mounted to an interior surface of the cavity through an interceding pedestal.

Example 28 includes the system of any of Examples 25-27, wherein the cavity has a dominant TM₀₁ mode.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
one or more electronic devices, wherein at least one electronic device in the one or more electronic devices receives a first input signal and provides an output signal, wherein the at least one electronic device comprises:
a conductive body enclosing a cavity, wherein the cavity has a dominant TM₀₁ mode; and
one or more components mounted within the cavity, wherein at least one of the one or more components is a resonator and some of the one or more components are dielectric components.

2. The system of claim 1, wherein the resonator is a dielectric resonator having a dielectric surface adhered to an interior surface of the cavity.

3. The system of claim 1, wherein the resonator is a dielectric resonator that is mounted to an interior surface of the cavity through an interceding pedestal.

4. The system of claim 1, wherein at least one of the dielectric components are coated with a metal.

5. The system of claim 4, wherein the metal is at least one of:
silver;
copper;
gold; and
tin.

6. The system of claim 1, wherein the resonator comprises two or more portions that are shaped differently than one another.

7. The system of claim 1, further comprising one or more tuning elements inserted through an external surface of the conductive body, the one or more tuning elements extending through the external surface into an axial center cavity formed in the resonator, wherein a distance that the one or more tuning elements extend into the axial center cavity is adjustable.

8. The system of claim 1, wherein the at least one electronic device is a filter.

9. An apparatus comprising:
a conductive body having a cavity within, wherein the cavity has a dominant TM₀₁ mode; and
a dielectric resonator inserted into the cavity within the conductive body, wherein a dielectric surface of the dielectric resonator is adhered to an interior surface of the cavity.

10. The apparatus of claim 9, wherein the dielectric resonator comprises two or more portions that are shaped differently than one another.

11. The apparatus of claim 10, wherein the dielectric resonator is a hollow cylinder and a first portion in the two or more portions is thicker than a second portion in the two or more portions, and the second portion is between the dielectric surface adhered to the interior surface and the first portion.

12. The apparatus of claim 9, further comprising one or more tuning elements inserted through an external surface of the conductive body, the one or more tuning elements extending through the external surface into an axial center cavity formed in the dielectric resonator, wherein a distance that the one or more tuning elements extend into the axial center cavity is adjustable.

13. The apparatus of claim 9, wherein the dielectric surface adheres to the interior surface using an adhesive.

14. An apparatus comprising:
a conductive body having a cavity within, wherein the cavity has a dominant TM₀₁ mode; and
a dielectric resonator mounted to an interior surface of the cavity, wherein the dielectric resonator comprises two or more portions that are shaped differently than one another.

15. The apparatus of claim 14, wherein a dielectric surface of the dielectric resonator is adhered to the interior surface of the cavity.

16. The apparatus of claim 14, wherein the dielectric resonator is mounted to the interior surface of the cavity through an interceding pedestal.

17. The apparatus of claim 14, wherein the dielectric resonator is a hollow cylinder and a first portion in the two or more portions is thicker than a second portion in the two or more portions, and the second portion is between the first portion and a surface adhered to the dielectric resonator.

18. The apparatus of claim 14, further comprising one or more tuning elements inserted through an external surface of the conductive body, the one or more tuning elements extending through the external surface into an axial center cavity formed in the dielectric resonator, wherein a distance that the one or more tuning elements extend into the axial center cavity is adjustable.

19. An apparatus comprising:
a conductive body having a cavity within, wherein the cavity has an interior surface;
one or more dielectric resonators mounted to the interior surface, wherein the one or more dielectric resonators have an axial center cavity formed therein; and
one or more tuning elements inserted through an external surface of the conductive body, the one or more tuning elements extending through the external surface into the axial center cavity, wherein a distance that the one or more tuning elements extend into the axial center cavity is adjustable.

20. The apparatus of claim 19, wherein a dielectric surface of a dielectric resonator in the one or more dielectric resonators is adhered to the interior surface of the cavity.

21. The apparatus of claim 19, wherein a dielectric resonator in the one or more dielectric resonators is mounted to the interior surface of the cavity through an interceding pedestal.

22. The apparatus of claim 19, further comprising an additional tuning element that extends through the external surface at a location opposite to an associated tuning element in the one or more tuning elements.

23. The apparatus of claim 19, wherein a tuning element in the one or more tuning elements is a screw.

24. The apparatus of claim 19, wherein a tuning element in the one or more tuning elements is made from at least one of:
a metal;
a dielectric material; and
a metal-coated dielectric material, plastic or other metal-coated material.

25. A system comprising:
one or more electronic devices, wherein at least one electronic device in the one or more electronic devices receives a first input signal and provides an output signal, wherein the at least one electronic device comprises:
a conductive body enclosing a cavity, wherein the cavity has an interior surface;
one or more dielectric resonators, wherein a dielectric resonator in the one or more dielectric resonators comprises two or more portions that are shaped differently than one another and has an axial center cavity formed therein; and
one or more tuning elements inserted through an external surface of the conductive body, the one or more tuning elements extending through the external surface into the axial center cavity, wherein a distance that the one or more tuning elements extend into the axial center cavity is adjustable.

26. The system of claim 25, wherein a dielectric surface of the dielectric resonator is adhered to the interior surface of the cavity.

27. The system of claim 25, wherein the dielectric resonator is mounted to an interior surface of the cavity through an interceding pedestal.

28. The system of claim 25, wherein the cavity has a dominant TM₀₁ mode.
